(19) United States
(12) Patent Application Publication
(10) Pub. No.: US 2024/0281518 A1
(43) Pub. Date: Aug. 22, 2024

(54) Swapping Predator and Victim in the Metaverse

(71) Applicant: Wesley John Boudville, Perth (AU)

(72) Inventor: Wesley John Boudville, Perth (AU)

(21) Appl. No.: 17/803,991

(22) Filed: Feb. 21, 2023

(51) Int. Cl. G06F 21/50; G06T 13/40

(52) U.S. Cl. CPC G06F 21/50; G06T 13/40

(57) ABSTRACT

A Virtual Reality (VR) site has a victim avatar and a Predator. The Predator touches an off limits area of the victim, sending the Predator to a punishment site (PS). The PS copies the Predator to a Fake Predator (FP), driven by a combat bot or human. The Predator's limbs are immobilised by the PS. The FP attacks the Predator. The Predator sees himself attacked by (apparently) himself. The VR site can instead send a copy of the victim to the PS. The FP attacks the copy of the victim. The visual feed seen by the victim is sent to the Predator. He sees himself as the victim attacked by the (fake) Predator. Or when the PS gets a copy of the victim, it makes the victim attack the Predator.

### BACKGROUND

The Metaverse is essentially Virtual Reality (VR) combined with a requirement that users use avatars. An avatar is a 3d skin worn by a user, when she goes to a VR site. The site may have links to other VR sites, run by the same operator or firm who runs the first site. Or the site might have links to VR sites run by different operators or firms.

A link is put in the first site. A user uses her avatar to click the link, which takes her to a destination site. But given rampant bad behavior documented for the Metaverse, she might be leery of doing so. Existing bad behavior includes sexual harassment, plus what some women have characterized as virtual rape.

There is little appreciation of what VR really can do, for a person with an avatar in a VR site. In this application, we describe in further detail several cases.

### BRIEF DESCRIPTION OF THE DRAWINGS

FIG. 1 shows an avatar in her underwear, with hyperlinks from these.

FIG. 2 shows the Predator sent to a punishment site, where audio and video is shown.

FIG. 3 shows the Predator and victim in a room and the Predator sent to a duplicate room.

FIG. 3a shows 3 Predators sent to a Punishment room.

FIG. 3b shows Ann moved to safety, Jack sent to punishment and Jack3 replacing him.

FIG. 3c shows Ann and Jack replaced by avatars run by the site.

FIG. 4 show 2 owners of avatars swapping their avatars.

FIG. 5a is a flow chart of swapping Predator and victim.

FIG. 5 shows the Predator in the body of a fake victim, accosted by a fake Predator.

FIG. 6 shows more details about a human controlling the fake Predator.

FIG. 7 shows a FoV of avatars, with a dot over avatars having off limits parts.

FIG. 8 shows FoV with filled boxes over avatars' off limits parts.

FIG. 9 shows the punishment site depending on VR site that avatar visits.

FIG. 10 shows a male Predator and a male victim.

### DETAILED DESCRIPTION

What we claim as new and desire to secure by letters patent is set forth in the following.

This application has the sections:
0] Definition of Metaverse;
1] Problem;
2] Earlier countermeasures;
3] Duplicate room;
4] Swapping avatars;
5] Swapping due to molesting an avatar;
6] Predator is halted;
7] Showing avatars with off limit areas;
8] Baiting a Predator;
9] Who can make a Jump hyperlink;
10] Automatically putting a Jump hyperlink on an avatar;
11] Non sexual assault;

### 0] Definition of Metaverse;

We take a pragmatic definition of Metaverse as being VR plus the use of avatars within the VR sites. This sidesteps various hyped-up discussions of what a Metaverse might or can be. But the requirement of VR can even be optional. So what a user sees can be a 3D environment similar to what is often shown in multiplayer combat or car driving games. In this case, avatars are often still required. This is the key point. We describe a multiuser computer application, where avatars are present.

1] Problem; Metaverse sites are plagued with Predator avatars. These are typically male avatars, run by human males. The Predators molest female avatars. The latter are typically run by women, who might find that their avatars being molested is traumatic. Equivalent to rape, as described by some women.
2] Earlier countermeasures; In recent patent applications, we described various countermeasures that can be taken to protect women. Application Ser. No. 17/803,218 “Metaverse avatar wearing a clickable link” put a clickable hyperlink on the surface of an avatar or on her clothing. The link went to a second site. If a Predator touched the link, he is “Jumped” (=transported) to the second site. Application Ser. No. 17/803,359 “Metaverse anti rape measures—part 2” described where a female avatar can have a link from her bra to a second site. And a link from her panties to the second site. When the Predator touches either, 3 things happen.

First. The Predator is immediately separated from the victim, giving her protection from him.

Second. At the second site, audio and video are shown to him. The audio might be of fingernails on a blackboard. Video can be of (eg) an unpleasant and nauseous experience. The audio and video make a deterrent to the human operating the Predator, to discourage him from future acts.

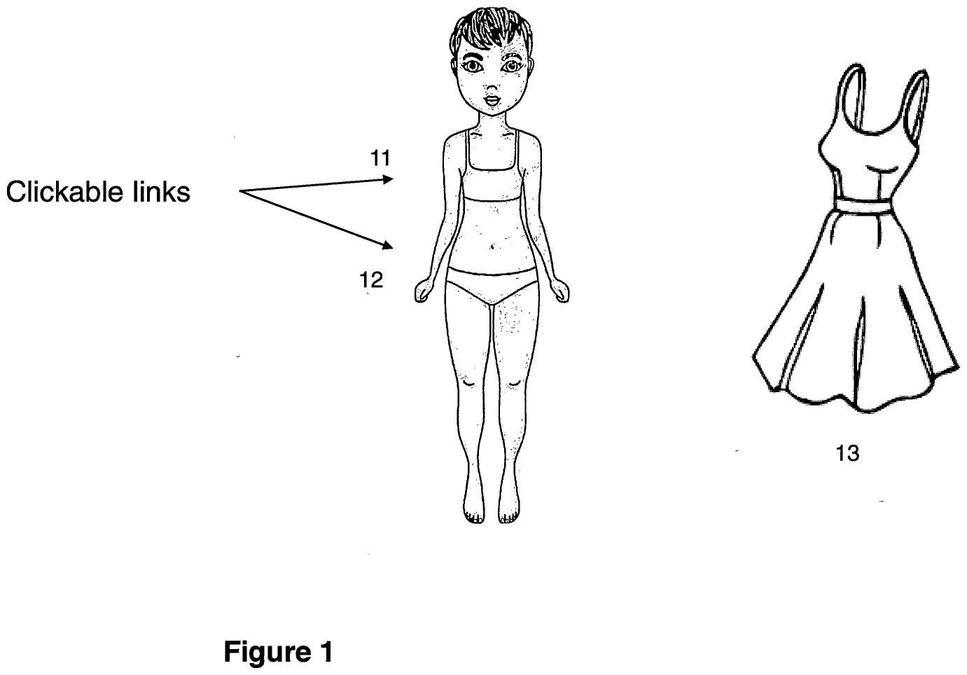

FIG. 1 shows an avatar in her underwear—bra and panties. With hyperlinks from these to a punishment site. The reader is undoubtedly familiar with using a web browser, that shows a webpage with links in it. And that by clicking a link, the reader is sent to the webpage pointed to by the link. The use of a link in the current application follows this prior usage. Except that in the Metaverse, a Predator avatar is used.

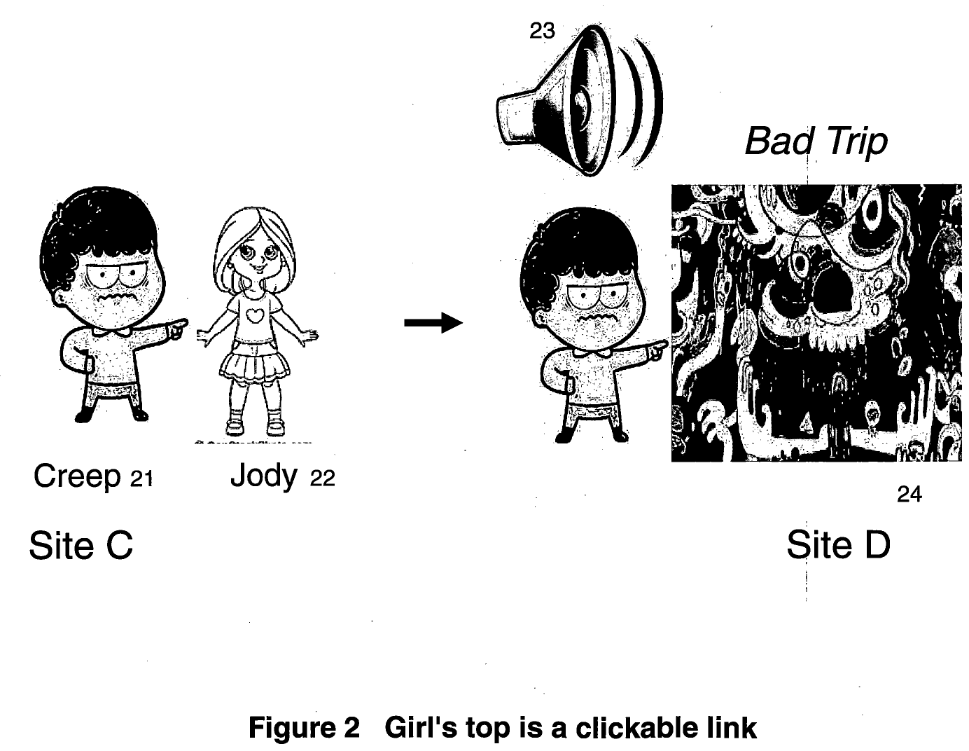

FIG. 2 shows the Predator being sent to a punishment site, where audio and video are shown to him.

Third. Countermeasures can be done to hamper the Predator hitting the equivalent of a Back button on the HUD rig worn by the operator of the Predator. So the Predator trying to go back to the first site can be delayed. This gives more time for the female avatar to leave the first site. Or for the site to prepage other measures to use against the Predator when or if he eventually does return to the first site.

We shall write about [eg] the Predator's mind or the victim's mind. By this we mean the minds of the operators of those avatars.

### 3] Duplicate Room;

In the previous section, the showing of audio and video to the Predator aims at punishing him in some fashion for molesting female avatars. The point is to associate the negative experiences of watching the audio and video with his recent action of groping the female's underwear. One variant is where the first site makes a (quasi) duplicate of several of its rooms or regions. These rooms are devoid of avatars. But otherwise, in terms of the layout and furnishings, the rooms look similar to the original rooms in the site.

When the Predator touches a female's underwear in a room of the (first) site, he is sent to a duplicate room and audio and video are shown to him, as earlier described. Here, the point is for him to associate the negative aspects of the audio and video with a room similar to the original room where he groped the female. Ideally, the Predator is dissuaded from trying at some future point to return to rooms of the first site and molesting female avatars. A negative association is made in the Predator owner's mind between the room and the molesting act.

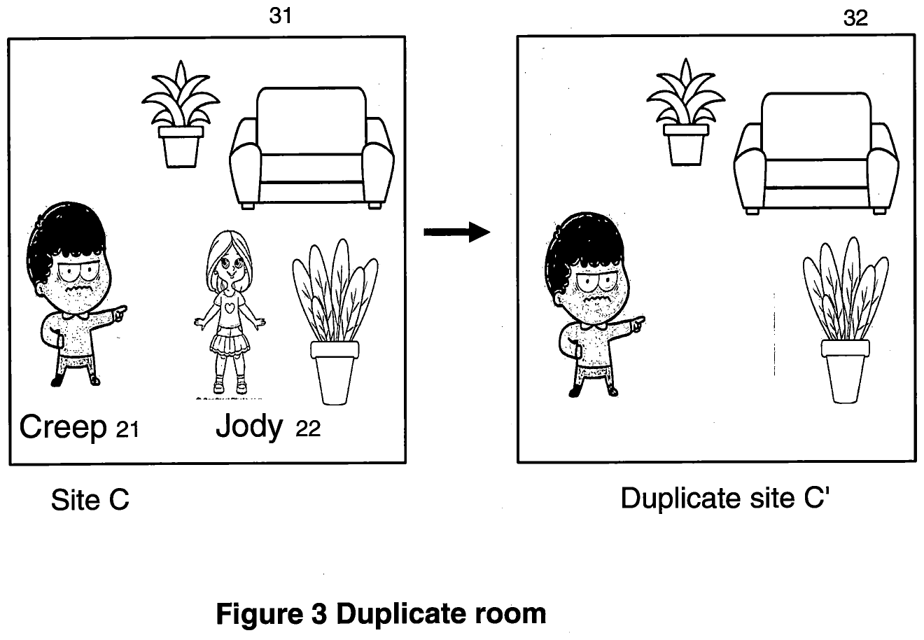

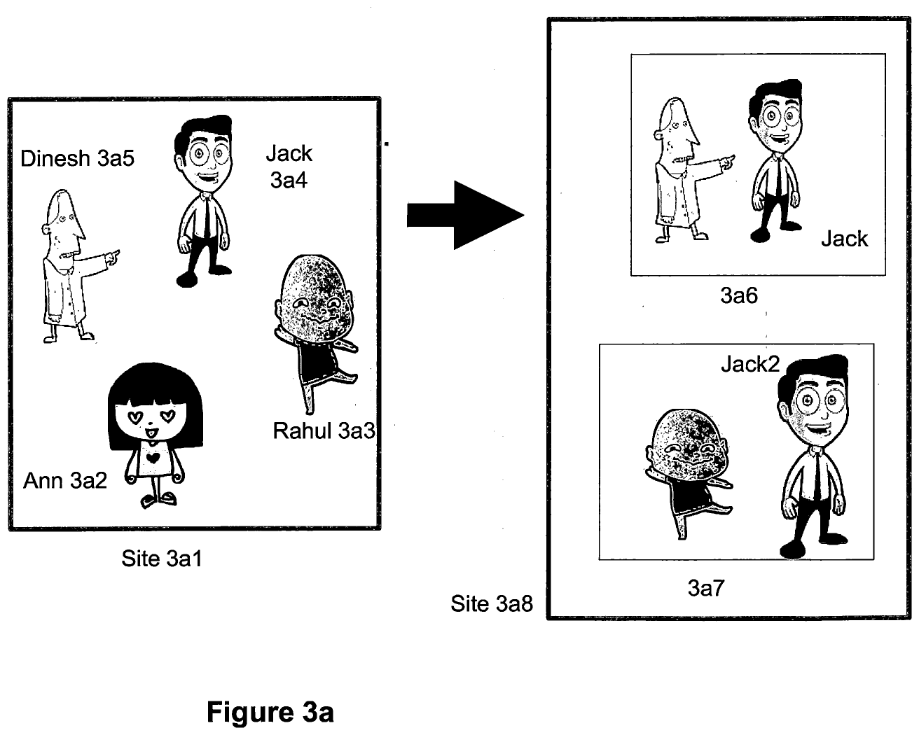

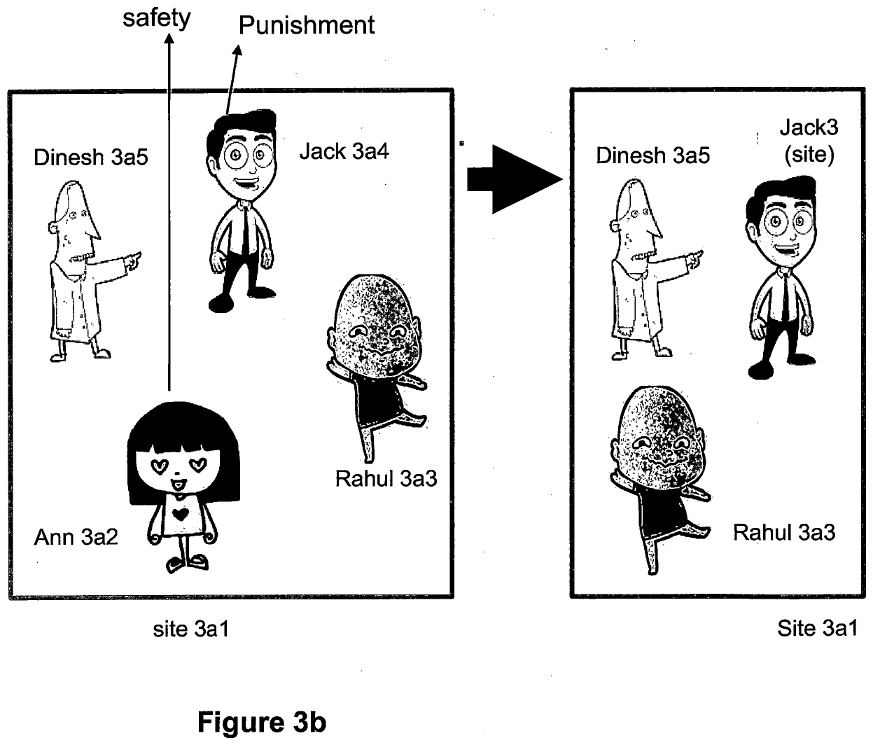

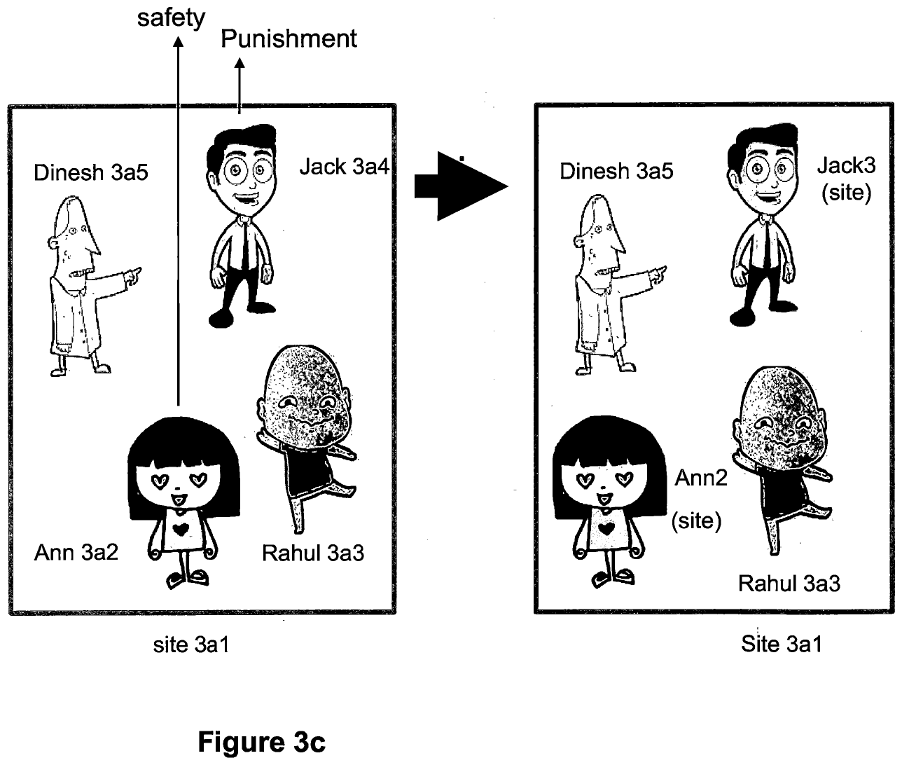

FIG. 3 shows the Predator 21 and victim Jody 22 in site 31 (site C). After he gropes her underwear, he is sent to duplicate site C′ 32. Site 31 has a room. The duplicate room 32 is considered to be at site 31, in a different part. The point is that the furniture and furnishings in 32 is the same as in the room shown on the left in site 31.

The duplicate room does not have to be an exact duplicate of the original room. We wrote duplicate out of convenience. But as much as possible, the layout of the room and its furnishings should be similar or an exact copy. Given that this happens in virtual reality, the copying of furnishings and wall paintings (etc) can be trivially done, at a marginal cost of 0. And VR proponents have often stressed that in VR, space is effectively unlimited. One consequence is that the steps in this section have little tangible cost to the site.

Note that when the Predator is being subjected to bad (in his perspective) audio and video, he can still see around him what appears to be a close if not exact copy of the room where he did the molesting. He is unlikely to look closely to find any differences between the room he is currently in and the earlier room.

The audio and video can loop endlessly. The intent is to keep him in the duplicate room as long as possible. And the looping gives more time for him to remember the room.

Another possibility is for Non Player Characters (NPCs) to be introduced to the room. They are essentially bots with a visual skin. The NPCs can attack or harass him. If or when he defeats some, new NPCs can be made. This also applies if he is sent fully offsite to a punishment site, as stated in earlier applications.

When we refer to “room”, it could also be an “open air” setting, with gardens and trees and buildings. Here, there might be no visible perimeter of a room, but the quasi duplication of gardens and trees is the equivalent to our earlier statements.

A related scenario is where after the first Predator is Jumped to either a punishment site or a duplicate room, then a second Predator is Jumped to the same destination. To minimise computational effort, the second Predator is shown the same audio and video as the first Predator. Instead of generating new, different audio or video for the second Predator.

Having 2 Predators in the same punishment site at the same time also allows for another scenario. The punishment site might immobilize the first Predator's limbs. And it can take control of the second Predator's body and use it to attack the first Predator. Then, after some time, this is reversed, with the first Predator controlled by the site and attacking an immbolized second Predator. One effect is to engender suspicion between the Predators, for future interactions. Another effect is to traumatise both.

This possible turning of the Predators against each other can be useful. Some users of computer sites have reported for groups of (male) avatar molesting female avatars. The male avatars are acting in coordinated manners. But a site can take control of an avatar's body and the site controls what visual feed an avatar sees. This gives a fine grained power of control.

See FIG. 3a. We have a site 3a1 With 3 Predators Rahul 3a3, Jack 3a4, Dinesh 3a5 and a victim Ann 3a2. The Predators molest Ann and this is detected by site 3a1. It sends the Predators to the punishment site 3a8. The punishment site has 2 rooms, 3a6 and 3a7. It puts Dinesh in 3a6 and Rahul in 3a7. It makes a copy of Jack, Jack2, and puts Jack2 with Rahul. The original Jack is put with Dinesh. Jack2 is never under control of the owner of Jack. Jack2 can be animated by a bot. Jack2 attacks Rahul. Jack's limbs can be under the control of the punishment site. Jack attacks Dinesh. Fundamentally, there is no difference between Jack and Jack2.

By the Jacks attacking the other 2 avatars, their owners can be made suspicious of Jack. This might deter Dinesh and Rahul from working with Jack in the future.

An important variant is the following. See FIG. 3b. We deterministically identify Jack as the avatar who touches and molests Ann. But it may be that id-ing Dinesh and Rahul as his accessories is more difficult. So Jack is copied and the original Jack is sent to the punishment site. Ann is sent to a different room in the current site, so that she is away from Dinesh and Rahul. An explanation is sent to her, via perhaps text and audio, where this is clearly marked as coming from the current room. But in the current room 3a1, a copy of Jack is made, Jack3, and replaces the original Jack. As indicated in FIG. 3b, Jack3 is run by the site.

A plausible scenario is that the 3 are in collusion and found or maneuvered Ann to be isolated from other avatars, before she was molested.

Jack3 listens to what the other 2 broadcast as text and audio, to the extent that this is possible. It may be that Dinesh and Rahul are conversing in an encrypted manner and that they are also doing so with the original Jack, before he was removed. So Jack3 is unable to listen in or interact with them via that channel. But in this case, where Dinesh, Rahul and the original Jack were using joint encryption, the site can reasonably assume they are all in collusion. It can also punish Dinesh and Rahul, as described earlier.

But it may be that Dinesh and Rahul are not using encryption with each other or with Jack. They might be talking or texting openly. Jack3 can listen and he, who is the site operator, can decide if they are in collusion. If so, they are punished.

Another case is where Dinesh and Rahul are using an encrypted channel with each other but not with Jack. Dinesh and Rahul might actually be innocent. So Jack3 keeps listening to them. Perhaps he says non-committal remarks. (“I don't know where she went! Maybe she found a more interesting site?”) Here, Jack3 might be listening for remarks from Dinesh or Rahul like [to Jack] “Why did you grope her?” or “You should not do that.” These tend to signify that Dinesh and Rahul are innocent. But if Dinesh says [to Jack], “I wanted to grope her next!”, this indicates that Dinesh is also in cahoots with Jack. Likewise if Rahul makes similar remarks.

A different scenario is where the site duplicates Ann into Ann2. See FIG. 3c. Ann is still sent to another room or a different site, for her safety. Ann2 replaces Ann in FIG. 3c. Note that Ann2 is similarly “armed” with hyperlinks as Ann was. Ann2 and Jack3 are now controlled and run by the site. As far as Dinesh and Rahul can tell, Ann2 is the original Ann. From above, they might be able to tell that there is something off about Jack3 if he cannot remain in an encrypted conversation with them. But because in general, Ann/Ann2 was never in an encrypted conversation with them, they should not be able to tell that Ann2 differs from Ann.

The key point here is that Ann has just been groped by Jack. But Ann is apparently still in site 3a1, which is the general case when our protective methods are not in use. Now the site, via Ann2 and Jack3, can listen carefully to what Dinesh and Rahul say, as this is likely to indicate their true intents.

For example, if Dinesh says to Ann2, “Did you like it, dear?”, referring to the just completed grope by Jack, then Dinesh is likely working with Jack. Ditto if Rahul makes similar remarks. Whereas if Rahul says to Jack2, “Don't do that!”, it suggests that Rahul is innocent.

And the major point that Ann2 is still (apparently) in the site, may tempt Dinesh and Rahul to try their luck in molesting her. If they do this, our hyperlink Jump method will catch them, just as it did Jack. This potential drawing out of them as Predators adds to the efficacy of our method.

Our analysis here of a situation with 3 unknown avatars near a female avatar can be extended to more avatars being present. It gives a site the means to classify and deal with groups of Predators. We can use the nature of VR to move away innocent (Ann) and guilty (Jack) avatars. And by replacing them with avatars (Ann2 and Jack3) that are extensions of the site, we can break apart an unknown group of avatars into smaller groups for further analysis and possible punishment.

Another variant is where in a site or room with a Predator and victim and other avatars, of unknown intentions, when the victim is molested, the Predator is sent to a duplicate room. Now the victim and other avatars are duplicated and run as NPCs. The other “avatars” are in the same places as in the first room. Now all of these can shout at the Predator (eg “Hey stop that”, “Leave her alone”). And they can approach and attack the Predator.

If some of the avatars in the first room are accomplices, then the attack in the second room by them may puzzle him.

But the attack by the unrelated avatars can be the main feature. It is meant as a deterrent.

A variant of the above is where in the original room, when the Predator molests the victim, the Predator remains in the room. But the other avatars, including the victim, are moved to a duplicate room. And they are duplicated into NPCs, that appear in the first room, at the locations of the original avatars. These NPCs can attack the Predator.

### 4] Swapping Avatars;

A human Bob owns avatar Tim. A human Jane owns avatar Linda. Tim and Linda are in the same site and near each other. The owners Bob and Jane want to swap ownership of their avatars. This might be for a limited time, after which the ownership reverts to the original case. Or the swap might be permanent.

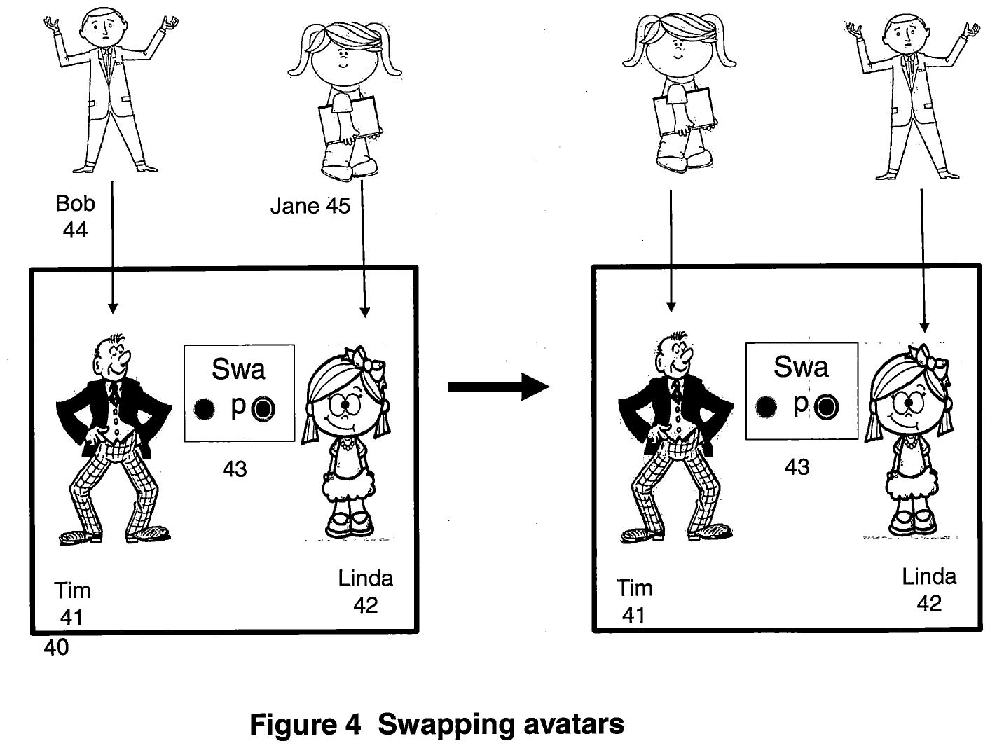

Tim and Linda are in front of a “Swap” apparatus run by the site. There are 2 buttons on the apparatus. Tim and Linda each press a button. The site checks Tim and Linda for the presence of unusual or suspect code. If none is found, the site sends Tim to Jane's rig. Or computer. And sends Linda to Bob's rig or computer. Jane takes ownership of Tim. Bob takes ownership of Linda. FIG. 4 shows this. Item 40 is the site the avatars are both at. Note that the figure shows a convention where after the swap, in site 40, the avatars remain in their prior-swap positions. While the humans do not physically swap their positions (they are in different places), the arrows leading from a human to an avatar are meant to show that the ownership has changed.

There is the other alternative, where the avatars themselves are swapped in their locations. In both cases, of course, the owners remain at their locations.

The site acts as a trusted third party. Bob and Jane do not exchange avatars directly. The site has information about Bob's rig hardware and Operating System. And ditto for Jane's rig hardware and Operating System.

The site can run simulations of Bob's rig running Linda. And for Jane's rig running Tim. If the simulations run well, with no problems, then the site can advise Bob and Jane that they can exchange avatars. If there are problems, the site can inform them. The site might modify Linda and Tim to be runnable on new VR hardware and operating systems. If need be, the site can make modified Linda and Tim and these are then passed to their new owners.

The site can perform its actions for a fee paid by the owners.

### 5] Swapping Due to Molesting an Avatar;

In the previous section, the avatars are acting in a cooperative and benign manner. But the situation in the present section is where a male avatar acts as a Predator towards a nearby female avatar. The site detects this triggering of a hyperlink (a “Jump”). Here the Jump can be either to a dedicated punishment site, or to a “duplicate” room maintained by the site.

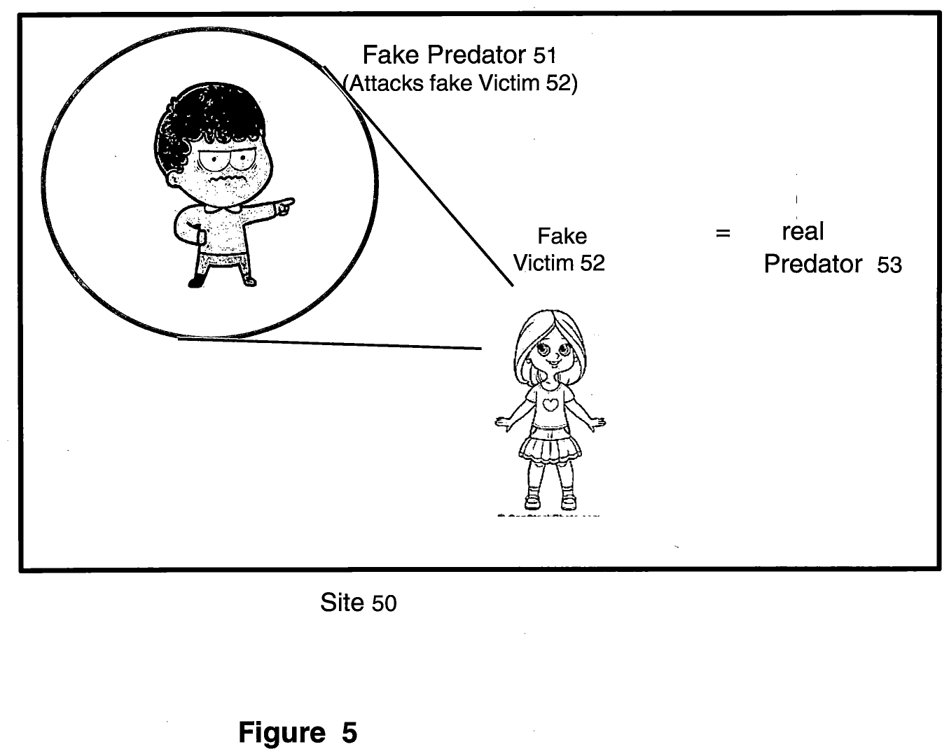

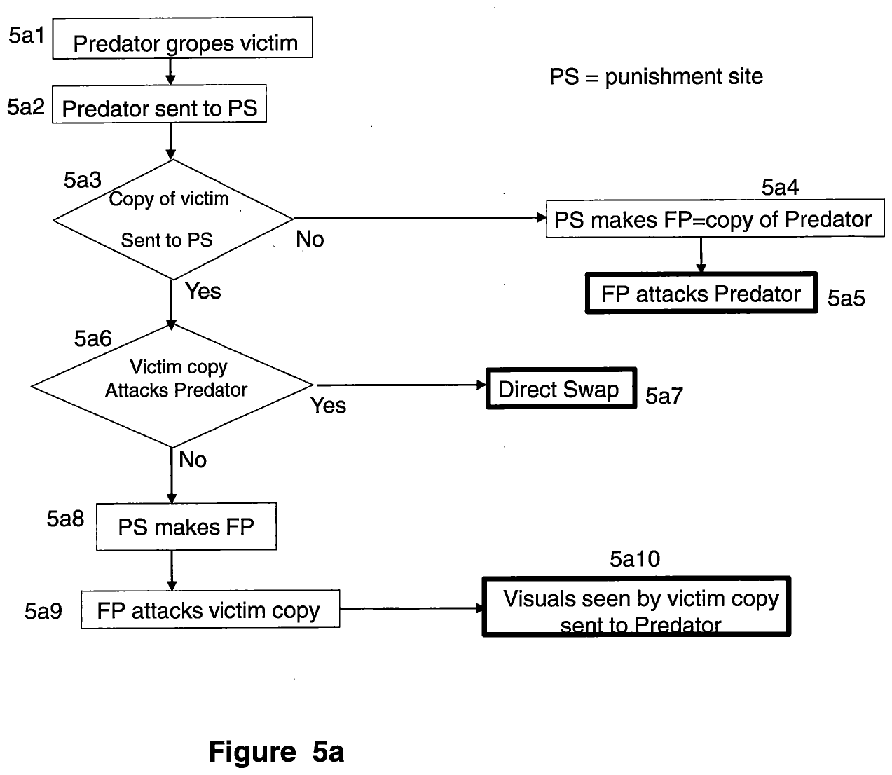

See FIG. 5a. It is a flow chart summarising this section. Start at item 5a1. The Predator gropes the victim. This is detected using our previous application “Metaverse anti rape measures—part 2” Ser. No. 17/803,359. The Predator is sent to the punishment site (PS) in item 5a2.

Item 5a3 is a key decision point. Is a copy of the victim sent to the PS? If no, go to item 5a4, where the PS makes a copy of the Predator into a fake Predator (FP). The FP is animated by the PS. Perhaps using combat software (=a combat bot). Or perhaps using a human. Item 5a5 is where the FP attacks the Predator. So the Predator sees a copy of himself attacking him. This is a first instance of a swap, where the Predator is now defending himself.

But perhaps he cannot. A key step here, and not shown in FIG. 5a (for brevity) is for the PS to immobilise the Predator's limbs when he is transported to the PS. This deliberately increases his helplessness before the attack by a copy of himself.

In item 5a3, suppose a copy of the victim is sent to the PS. This is possible because when the groping occurred in the first site, the clicking of the hyperlink to Jump the Predator to the PS tells the first site the victim avatar. Then in item 5a6, the PS has a copy of the victim. The PS can animate this, perhaps using a bot. Or even using a human. 5a6 asks, does the copy of the victim attack the Predator? If yes, we end up at item 5a7, which we term a direct swap. This is a stronger measure than 5a5. Now in 5a7, the Predator finds himself attacked by what appears to him to be his victim. Even if this is only a copy, and not animated by whoever animated the original victim, he cannot discern this.

But consider when the animation of the copy of the victim is done by a human, recruited perhaps by the punishment site. A crucial case is where this human is the person (likely a woman) who owns the victim avatar. The actions in item 5a7 of her actively controlling a copy of her avatar to pummel the Predator can be of potent therapeutic benefit to her, to overcome any trauma she may have experienced in the previous site at the hands of the Predator.

Consider in 5a3 where a copy of the victim is sent to the punishment site. In VR, the difference between a copy of the victim and the victim can be blurred. The first site might send the victim herself to the punishment site. This might depend on the person (woman) owning the victim agreeing to this. Then 5a6 asks “does the victim attack the Predator” ? If so, we go to the “Direct Swap” 5a7. The benefit here to the victim (ie. the owner of the victim) is that she can herself pummel the Predator. Rather than having a copy of the victim do so, when the owner likely never sees/experiences this for herself.

A similar effect can happen if in 5a3, the Punishment site activates a female avatar, Nicole that does not look like the victim in the first site. The punishment site can use a bot or a human to animate Nicole, and have her pummel the Predator. This can be beneficial, even if the Predator does not recognise the female. Perhaps the Predator was harassing females in general. So Nicole, representing a typical female might be a useful response.

This can be appropriate if, eg, it was noticed that a Predator was harassing victims of a certain race or ethnicity. So having Nicole being of that background is germane.

This punishing of a sexual harasser is a socially positive effect.

Haptic effects can also be used, if the Predator or victim have these enabled. For example, when the copy of the victim hits the Predator, the impact of the blow can be transmitted to the Predator, and thence to the human operating the Predator. While the recoil impact (Newton's Second Law) on the copy of the victim can in turn be transmitted to the human controlling the copy of the victim. The point of haptic effects is to increase the verisimilitude of actions in VR, and this is what happens.

It is possible that (eg) the Predator has haptics enabled by its hardware, and the copy of the victim does not have haptics enabled by its hardware. Then only the user of the Predator will feel any haptic effects from the interaction with the copy of the victim.

Thus the swap can have 2 positive effects. Healing the victim. Punishing the Predator.

Ending at 5a7 is a key destination. It increases the psychological pressure on the human running the Predator.

A useful variant of the above is where at item 5a6, the copy of the victim is animated specifically by the human who owns the female avatar that got molested. This can be therapeutic for the human.

Back at 5a6, suppose the victim copy does not attack the Predator. Item 5a8 has the PS make a fake Predator. As was done earlier in 5a4. But now in 5a9, the fake Predator attacks the copy of the victim. The PS can perhaps animate the victim copy to a minimal extent. The point is item 5a10. The visual feed seen by the victim copy is sent to the visual feed of the Predator. This is also a good outcome. It lets the Predator experience an attack on what appears to be the victim, and he is the victim, by what appears to be a copy of the Predator.

Items 5a7 and 5a10 can be considered a “full” swap of Predator and victim. Item 5a10 has the Predator being held by the PS in “stasis”, while the action is happening at the fake Predator and at the copy of the victim.

If the punishment site gets a copy of the victim, or the victim itself, the site can make several copies. It can then animate these and use them against the Predator. Here, the intent is to induce trauma in the Predator by having to fight several victims simultaneously. A variant is where the punishment site makes single copies of female avatars who were previously molested by Predators. And then the site sends the group of these copies against a Predator.

A variant is where the punishment site might also make copies of male avatars. These avatars might have been originally run by husbands or boyfriends of the molested females. Then the group of males and females could be sent against a Predator.

Another variant is where the avatars can be accompanied by avatars of dogs, lions, etc Or by avatars of imaginary creatures, like vampires, werewolves.

When the Predator is in the punishment site, instead of the site immobilizing him, the site could let him use his limbs at [eg] quarter strength, and at [eg] a third his normal speed.

A variant is where the Predator body can be altered so that his limbs can be torn off by other avatars. And his ears can be torn off, his eyeballs gouged out, his teeth knocked out, his fingers torn off. The point is to make a Predator have mods so that his body can be mutilated by others in the punishment site. When the owner of the Predator makes the Predator, it does not have such “functionality” [so to speak]. But when the Predator jumps to a site, the body of the Predator is instantiated as a copy of the original body. Depending on the sophistication of the site that the Predator appears in, the site may be able to make such a body; ie to modify the original design of the Predator so that the body can be “altered” (torn apart) as described here.

In this situation, it is likely that when the Predator first appears in the site, the Predator is unknown to the site. The site cannot make such mods without the Predator actually having done something wrong. But if the Predator then molests a victim on the site, and this is detected, then if the site sends the Predator to a punishment site, the latter can do such mods to the Predator body. Or in the first site, if it detects the Predator molesting, and the site Jumps the Predator to a different room on the site, then as part of the Jumping, the site can alter its body.

The remainder of this section goes into more details.

FIG. 5 shows the punishment site 50. Holding fake Predator 51 and fake victim 52. The latter is actually the Predator Jumped to this site after he molested a (real) victim. Or, the punishment site can hold the (real) Predator 51 in a separate area of the site, and send it the visual feed received by the fake victim. Because of the inherent nature of VR, whether the fake victim and the real Predator are considered to be the same or different is essentially moot. A specific implementation of the punishment site might hold 2 avatars—one a copy of the victim and one being the real Predator. A different implementation of the punishment site can, instead of the previous 2 avatars, just hold the real Predator and send a copy of the data feed, made for the fake victim, to the real Predator.

Fake Predator 51 is shown in the visual feed of avatar 52. Note that fake victim 52 is depicted in the figure as looking the same as the victim in earlier figures. In actuality, avatar 52 might look like the Predator. So FIG. 5 actually shows a fake Predator 51 and avatar 52 being the real Predator.

The reader might object that the preceding paragraphs are complex and clumsy. That may well be so. But it is inherent in the use of virtual reality. And in the use of this language (English or whatever other language this application might be translated into). A natural human language might lack the means to effectively describe copies of an avatar and the funneling of an optical feed. Because in the real language, in which natural language was meant for, these issues of identity do not much arise.

So the punishment site has copies of the Predator and the victim. It can re-animate both of them to fight, and the real Predator watches thru the victim's eyes. The punishment site does not need to concern itself with the lack of a human to control the female avatar. A key point here is that the female can be modelled by a simple bot. She can just go thru a minimal set of motions.

In FIG. 5, the punishment site is not subjecting the (real) Predator to audio and video that are the punishments described in earlier applications. (Examples: fingernails on a blackboard, a bad acid trip.) Instead the punishment is what is described here, in this application.

And when the real Predator sees the fake Predator attacking him, it can be expected that the actions of the combat bot will be close enough to the actions of the real Predator (if it is actually attacking a victim) to persuade the real Predator that somehow, he is seeing thru the eyes of the victim. In combat gaming (in a non-VR context), there is now over 30 years of experience in coding such combat software that the belligerent actions of the fake Predator are plausible to the real Predator watching thru the victim's eyes.

Also. When the real Predator is in the punishment site, the arms and legs of him might not respond to the commands of the human Predator. This can be tolerated by the J punishment site. It can make the real Predator be in a victim's body, where he can now no longer control her limbs. Increasing his sense of helplessness.

One way of doing this is when the human Predator uses the controls on his rig or computer, to move his (ie. the victim's) limbs, there is no visible response in his visual feed. Without this visual feedback, it appears that his limbs are unresponsive.

Because the steps might be confusing, we summarise them here. At punishment site 50,
[0] Punishment site gets the Predator and a copy of the victim.
[0.1] Make a copy of the Predator.
[1] Let bot Alpha control the copy of the Predator.
[2] Let bot Beta control the copy of the victim.
[3] Let bot Alpha attack the copy of the victim.
[4] Make visual feed at eyes of the copy of the victim.
[5] Send visual feed to the visual inputs of the Predator.

The above focuses (pun!) on the visual inputs of the Predator. It does not describe the Predator as experiencing any haptic feedback from the conflict. In part because haptic feedback is currently very primitive. But to the extent that future progress happens with haptic feedback, this can cause extra steps to be added to the above.

A variant of the above steps is where there is no explicit bot Beta controlling a copy of the victim. Instead, the copy of the victim might “react” as a minimally responsive entity, in response to the bot Alpha (or a human) aggressively attacking. Informally, the copy of the victim might act as a “rag doll” or “punching bag” while being attacked by Alpha.

We (re-)emphasise that in steps [0]-[5], the Predator and the copy of the Predator are different entities. See FIG. 5.

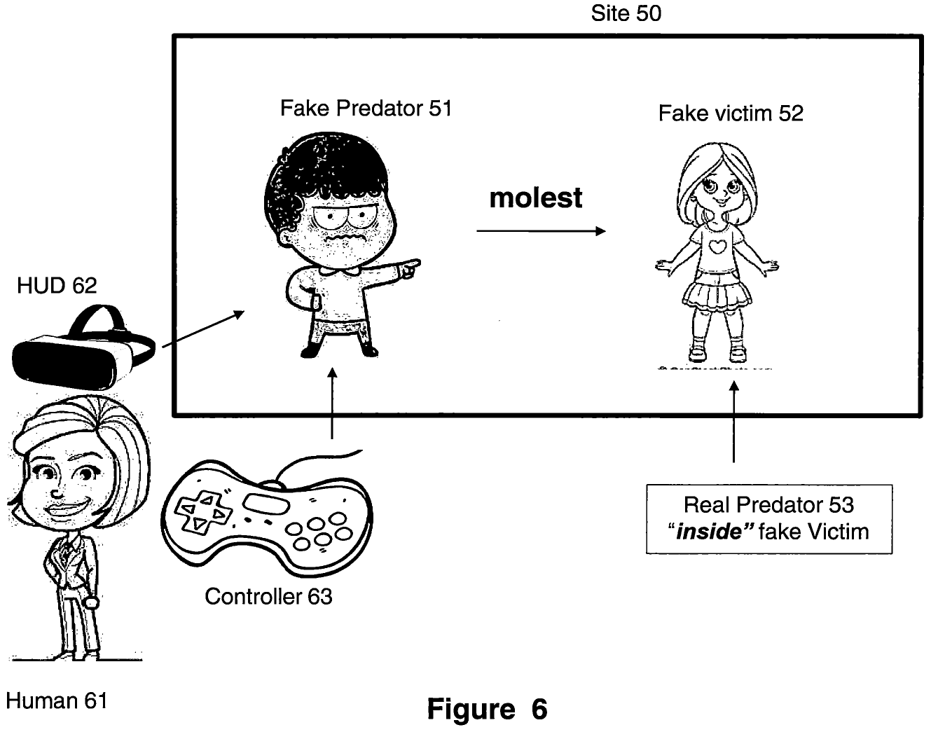

FIG. 6 gives more details. It shows human 61 using one or both of a HUD 62 and a controller 63 to control the fake Predator 51 in site 50. Items 62 and 63 are meant to be generic invocations of such devices. Item 63 is derived from photos of 1990s game controllers, but is not meant to actually need such devices. Item 63 signifies a controller whose controls can cause an avatar to do some (eg) combat-type moves. FIG. 6 also is not meant to preclude a bot being used instead of human 61.

FIG. 6 depicts a Controller 63 device. This might entail an accompanying digital screen showing a first person or a third person depiction of fake Predator 51. Whereas the HUD 62 device could have a screen being shown inside the device 62, or perhaps device 62 projects an image onto the retinas of human 61. The overall point is that human 61 uses one or both of devices 62 and 63 to (successfully) control fake Predator 51.

FIG. 6 also depicts “Real Predator 53 ‘inside’ fake victim”. The “inside” is not meant to be taken literally. It means that in actuality, avatar 52 is the real Predator 53, but he sees a visual feed as though he is victim 52.

The above actions put the Predator in (apparently) his victim's shoes. By him experiencing what his victim presumably undergoes, it can try to create in him empathy for her. This is largely impossible in the real world. To the extent that a Predator has a sliver of empathy, our methods amplify it against him. Thus the actions in this application can punitive or perhaps be rehabilitative.

The apparent putting of the Predator into his victim can be amplified by emplacing 1 or more mirrors in the punishment site. When or if the Predator sees himself in a mirror, he will see the victim. Because he sees himself in the first person, he might not immediately notice who he is meant to be, with mirrors absent.

Our remarks here about the punishment site pertain if the Predator is sent to a duplicate site of the first site. Here, there can be a momentary discontinuity if when he goes to the duplicate site, he will apparently be put into the victim's avatar. Ideally, when he appears in the duplicate site, he appears to be at his victim's location in the original site. And he is facing a fake Predator standing where he (the real Predator) was standing in the original site.

We explicitly suggest for the duplicate site that it can emplace mirrors near the Predator, to let him see himself portrayed as the victim. The mirrors can be achieved as reflective surfaces on the walls or ceiling of the site, for example.

Another aspect is when there are more than one avatar of Predators. (A gang.) Suppose there is the first Predator, who is the one who actually gropes the female's underwear. The other assailants might be standing nearby. The groping causes the Predator to be sent to the punishment site.

But it can also be sufficient cause to trigger a search for nearby assailants. This can be more difficult because the others do not do an active step of groping her underwear. But first the main Predator is sent to a punishment site, or to a duplicate site. The victim is now in the company of the others. The site can message her and ask if others are involved. If so, she might identify them to the site. The site can quickly check this with its records of avatars in the site.

Then the site can decide to transport one or more of them to the punishment site or duplicate site. The site might put all of them into getting a visual feed as the victim, being assaulted by the main Predator. This can have the salutary effect of getting some to see what the assault is like from the victim's perspective. Hopefully it might affect some or most to stop such future activities.

A simpler approach is for the punishment site to receive the Predator and the victim. The site immobilizes the Predator. It might also increase the speed or strength of the victim.

She can now pound him at will. This can be very therapeutic for her. And the Predator can be traumatised by it.

### 6] Predator is Halted;

Suppose there is 1 Predator and he gropes a female avatar. By touching her underwear. Prior to this, a link was made from her bra to a site section. And a link was made from her panties to the site section. The groping causes the site section to be activated.

One possibility is that the site freezes the Predator. While leaving him in the site. But the female avatar still keeps her ability to move. And, optionally, she can increase her speed and mass. She can then do so and fight him off.

A variant is where the Predator can still move, but slower than the victim. This is equivalent to the previous case where he cannot move and she just moves faster.

7] Showing Avatars with Off Limit Areas;

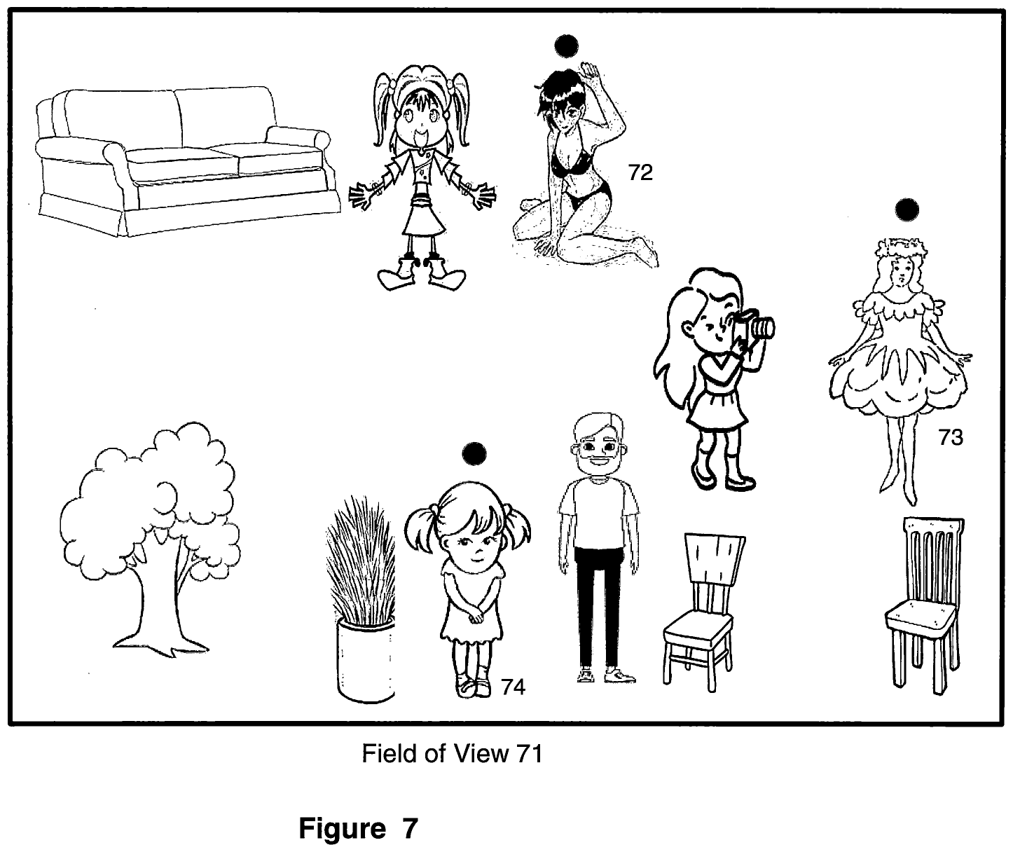

Suppose some avatars have off limit areas of their body or clothes. Imagine an avatar. If he (actually his owner, of course) pays the site eg $5/month, he can get an option to show which avatars in his Field of View (FoV) have these areas. This FoV does not show what parts of an avatar's body or underwear are connected to hyperlinks. But if he pays more, eg $10/month, he can get this extra information. FIG. 7 shows several avatars in the FoV. There are filled dots over avatars 72, 73, 74. These avatars have off limit areas. FIG. 7 does not actually show those areas.

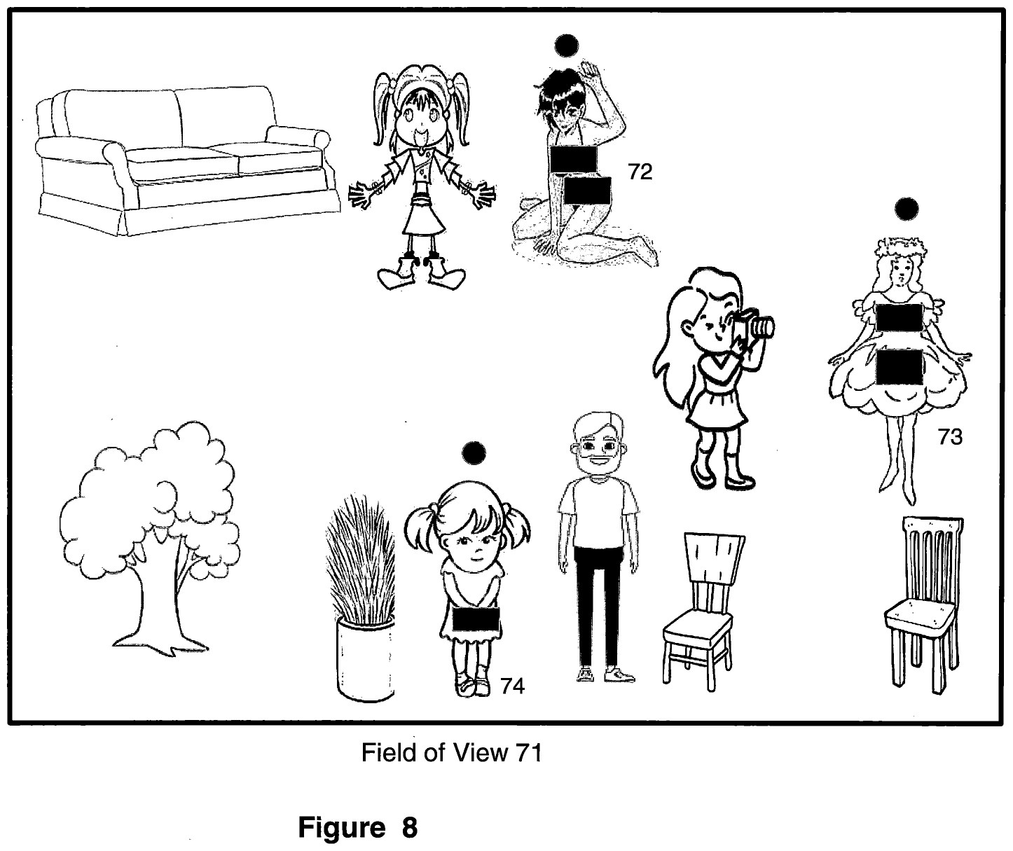

FIG. 8 shows where the sysadmin or moderator or just another avatar has chosen to get extra information about where on these 3 avatars are the off limit areas. See avatar 74. This is a prepubescent girl. Her off limit area is her panties. Likely the owner of this child avatar does not consider her needing to have her breasts/bra made off limits. Avatar 73 has off limit areas for her bra and panties.

Avatar 72 has her bikini off limits. Note that bikinis are usually considered outerwear and not underwear. But perhaps the “viewing software” that “made” FIG. 8 still puts the censor boxes over avatar 72. The censor boxes are meant to limit the chance of prurient uses of the viewing software.

### 8] Baiting a Predator;

Suppose a Predator molests in a site. His victims are female avatars with certain common properties. They wear certain types of clothing. Both outerwear and underwear. Or they wear similar types of jewelry or hats. Or have similar hairstyles. Or they wear similar shoes. The site can outfit an avatar in a similar way to the victims. The avatar can be controlled by a human. Or by a bot.

For avatars, the marginal cost of such actions is likely zero. Jewelry or fancy shoes can be replicated easily, for example.

These bait avatars can have accoutrements made with hyperlinks to a punishment site. Even if, or especially if the earlier avatars who were accosted did not have those hyperlinks from (eg) their jewelry or shoes. This suggests a possible surprise to the Predator, because he did not earlier meet the punishment hyperlinks.

By having the links on accoutrements, the bait predators can use these to easily touch him with them, to send him to a punishment site. The use of such external (to the body) links would typically be minimised because of the chances of accidentally touching an innocent avatar. The site might have to typically approve the deployment of these external links.

Suppose there are 2 bait avatars, Laura and Tammy. Each has links on her external surfaces and accoutrements. To some punishment site. It can be anticipated that if the avatars meet a Predator, they might be tussling with him. It is possible that Laura's accoutrement, that has a link, might touch Tammy, while both are trying to corner the Predator. Thus the site logic that is triggered when this happens needs to check the identity of the avatar who was touched and not send an innocent avatar away. The logic asks for the identities of the 2 avatars that touched. If both are the ids of the known bait avatars, then no jumping of one or both to a punishment site should happen. While if one id is of an unknown avatar, presumably the Predator, then send that avatar to the punishment site.

The preceding also, of course, applies when more than 2 bait avatars are used.

If the Predator had previously stolen or copied an avatar's shoe or jewelry, this is an opportunity for the site to make or buy a similar item and embed a unique id in the shoe or jewelry.

Another point of engagement is for the site to make an accoutrement whose location can be traced, by the site, and even across sites. The latter makes use of the property that an accoutrement can be worn, just like clothing. And clothing can, or should be worn across sites. When such an accoutrement is deliberately left in a location at the first site, this can be to induce a suspected Predator to take it.

A variant of the latter is when the item is sold to the Predator. He would buy via paying in some digital currency. If he pays with a real world credit card (or the equivalent), then this gives the site a way to id the Predator in the real world.

When the Predator wears the item and moves in the first site, the latter can surveil by often checking the item's location. A reason might be to see if the Predator then associates with others, who might also be considered Predators. Maybe the Predator also associates with some NPCs. Those might be under the control of the Predator. Or the Predator might be shifting active control from itself to one or more of the NPCs. Essentially transforming those into avatars. And turning the original avatar into an NPC.

A variant is where when the Predator takes over an NPC, that the owner of the Predator also retains control of the Predator. The time sharing control of 2 avatars is possible this way. In part, this can be achieved by a sophistication of an avatar's body. The body could have internal controls that auto-operate, to let the avatar move thru a site without explicit supervision (control) by a human. This is essentially how humans function. A human walks automatically. Only sometimes will the human explicitly take control of walking.

A useful point might be if the accoutrement is moved from the Predator to one of the NPCs or to another avatar. The Predator might be doing this to act as “cover” for concealing the ownership of the item.

One warning is that a smart Predator might get an accoutrement like a horse saddle. He finds an NPC horse and puts the saddle on it. Then he lets the horse roam the site, or even across sites. The horse can have a randomiser that lets it do this. The movements of the horse can act as a distractor to the site, in trying to track him. Or the Predator might put the accoutrement onto or in some object, like a box. The latter will be put into another object, like a bus, that moves in the site.

The idea of a “bug” that can be put on a Predator, to trace its movement, can be expanded. In the real world, an electronic bug can actively transmit a signal. But a VR bug does not need that ability. It does not need to, in general, broadcast an electronic wireless signal. And the site does not need, or have, a wireless receiver to pick up that signal. Instead suppose the bug can be emplaced on a Predator. Suppose the site has some type of id of the Predator. Or the site has an id of an item carried by the Predator, and the item contains the bug. Then when the site periodically looks up data on the Predator, the data includes the an item (with an id) that is or contains the bug.

How can the bug be put on the Predator? In the real world, the bug might need some material (eg glue) that lets it adhere to the Predator. In VR, the bug can be part of the data fields of an object, like clothing or jewelry, that the Predator might buy or find or steal as it traverses the site. The field in question could have a unique, randomly generated bit string. And the site might periodically look for this string in that data field. Then the site finds the location of the object that in VR has or contains that data field.

How can the Predator detect the bug? The Predator might have internal logic which runs and inspects objects acquired by the Predator. The logic would have to, or try to, inspect numerous data fields. It can try to discern if the fields make “sense”. If a field is for an object like a hat then the field might define decorations of the hat. The logic would have to find decorations that appear awry. The computational complexity of this can be daunting. Especially if the item of clothing has some random type visuals. Then the unique id could be hidden in that random signal.

It can be appreciated that in some ways it is easier to hid a bug in or on an avatar than on a real life person or device. There is little, if any, equivalent of a hardware spectrum analyzer used to find a hardware bug.

### 9] Who can Make a Jump Hyperlink;

Consider a female avatar wearing a bra and panties (and a dress over those). A hyperlink is made from her bra to a punishment site. In general, the owner of the avatar would like the link to be functional when the avatar goes from one site to another site. One issue is to focus on what happens when a Predator gropes a female avatar, triggering the Jump of the Predator to a punishment site.

We have an intersection of 2 avatars when this happens. The site finds the Predator and the avatar that he groped. What if the punishment destination is undefined? The site can maintain a default and functioning punishment site Phi. If the Jump is to an unknown place, the site can substitute Phi.

A variant is where the female avatar has defined a punishment site Rho in its hyperlink, but the present site overrides this with Phi. Perhaps the present site has analysed Rho and considers it too weak or permissive. So it substitutes Phi.

Or the present site considers Rho too harsh. So it substitutes Phi.

But the ability of a site to modify the punishment destination (at least while the avatar is in the site) can be subject to an override by the avatar (ie. the avatar's owner). There can be a mechanism where the avatar can keep its destination link only if the avatar pays the site a fee. The site earns some income. If the avatar declines to pay this to the site, the avatar would likely have to immediately leave the site.

The owner of an avatar might define the link (or links) and want these to be in effect and not subject to override by a site. Perhaps the owner has carefully found a good (from the owner's perspective) punitive punishment site. And does not want this altered to what the owner considers to be an inferior choice of punishment site.

Now suppose avatar Nora has a link to some punishment site. On social media, the owner of Nora has many approving comments about her choice of link. And perhaps the choice of link itself has many “likes”. This is very fine grained approval.

Then there is avatar Anita, who either has no link to a punishment site, or has one but she is not satisfied. Anita might get a copy of Nora's link, based on its ratings. In this way, a link to a punishment site can propagate from user to user (or avatar to avatar).

Another related aspect is where avatar Nora has several links, each link being for use in a given site or sites. This lets Nora customise her links to account for a system where sites vary greatly in how they handle visiting avatars.

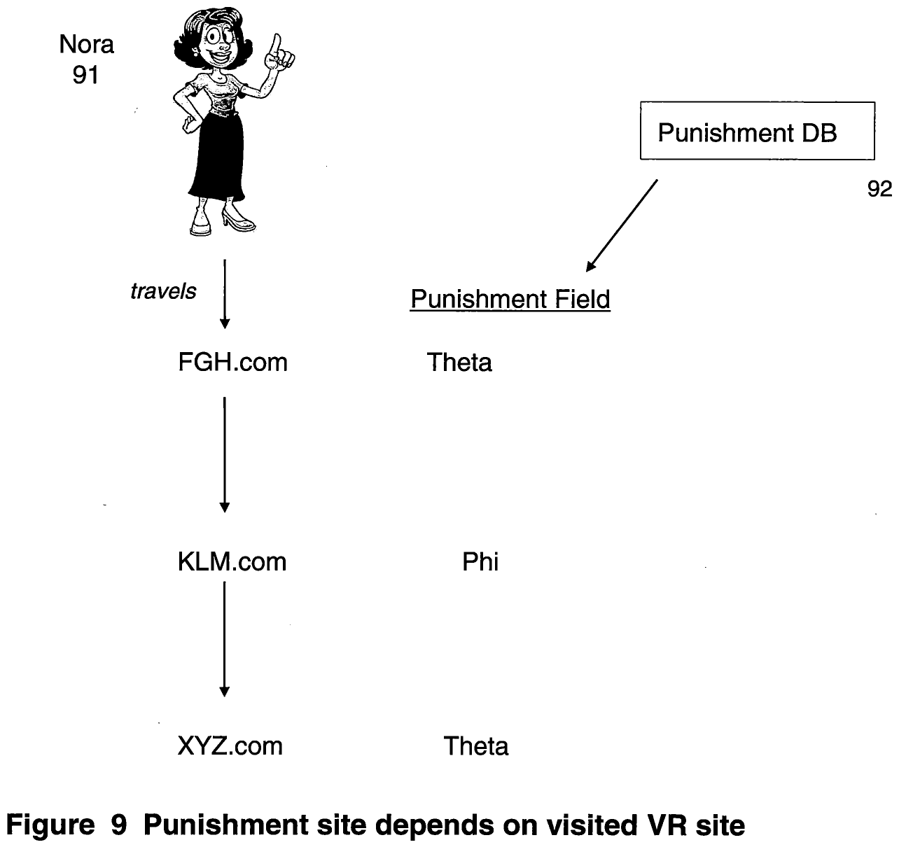

See FIG. 9. There might be the equivalent of code in Nora 91, so that when she moves to (eg) site FGH.com, the code finds a punishment link Theta associated with FGH.com, and puts this into the punishment field for her bra and panties. She might have a punishment database 92, with a punishment link and an associated site. And later when she moves to site KLM.com, the code finds a punishment link Phi associated with KLM.com and puts it into the punishment field for her bra and panties. Later, Nora moves to site XYZ.com. Now the punishment field for this site is the same as for the earlier site FGH.com, Theta.

Another variant is where when avatar Nora arrives at a site, she asks several avatars near her what link (if any) they are using. From the replies, she finds the most common link and installs it for her when she is in this site. This is equivalent to a type of immune response from a site. So that the most common link in a site is found and then used by a visitor to the site. This polling of avatars she newly meets in a site can be automated, instead of her manually asking nearby avatars. A parameter can be some kind of distance in the newly visited site, like 50 meters. So polling can be done within this radius. The avatars who are polled might not have to reply. But if they do, then the replies can be toted up.

A refinement is when avatars reply to Nora's asking, she can also ask for their reputations. The asking can be to the site she is in, or to an external authority (outside the site). She discards punishment links coming from avatars with (eg) reputations less than 3, out of a scale of 1-5, where 1 is lowest and 5 is highest.

A variant of the above is where when Nora leaves the site and later returns, she might use use the most common link she found from a previous visit, instead of re-polling the current avatars in the site for the latest popular link.

The punishment database can be valuable as a general resource for avatars. It might be independent of the sites, so that its advice on punishment links is not biased. One immediate use is for general sites, like FGH, KLM, XYZ in FIG. 9 to each have a blacklist of punishment sites, derived from periodically asking, or being informed by, the punishment database. As we described earlier, each general site should have a blacklist of (at least) the punishment site used by avatars that visit the general site. At that time, only 1 punishment site was described. But as we showed in this application, there can be several such punishment sites. It would behoove general sites to thus blacklist all the entries in the punishment database.

But while the punishment sites belong in blacklists for our anti-predator methods, there is a big difference between these blacklists and, eg, the blacklists for spam and phishing. In those, each entry is bad. If those blacklists were eventually empty, spam and phishing would have been defeated. But the punishment sites are vital to the successful operation of our anti-predator methods. They trap, for a while, the predators. And even attempt remedial actions to treat them.

### 10] Automatically Putting a Jump Hyperlink on an Avatar;

Suppose we have an avatar Nora who appears in a site. And suppose she has underwear, but does not have a Jump hyperlink from these to a punishment site. When Nora first appears in the site, it can scan her. If she is wearing underwear and the site can detect this and she does not have a link to a punishment site, the present site can make such links. It can use image recognition to scan Nora. This can assume that the site has an image of Nora in her underwear. Then after finding her underwear, the site can make that link and associate it with the underwear.

If Nora does not have underwear, the site can scan her and using a knowledge of human anatomy, find her erogenous zones and put a Jump hyperlink from those to a punishment site.

A variant of this is where the site has images of Nora fully clothed and finds that she does not have links to punishment sites. The site can find the areas of her dress covering her erogenous zones. And the site then marks those as having a Jump hyperlink to a punishment site. This goes beyond earlier work, because it does not target underwear.

But it uses a generally held attitude amongst women that the parts of the dress covering their breasts and groins should be off limits in real life.

### 11] Non-Sexual Assault;

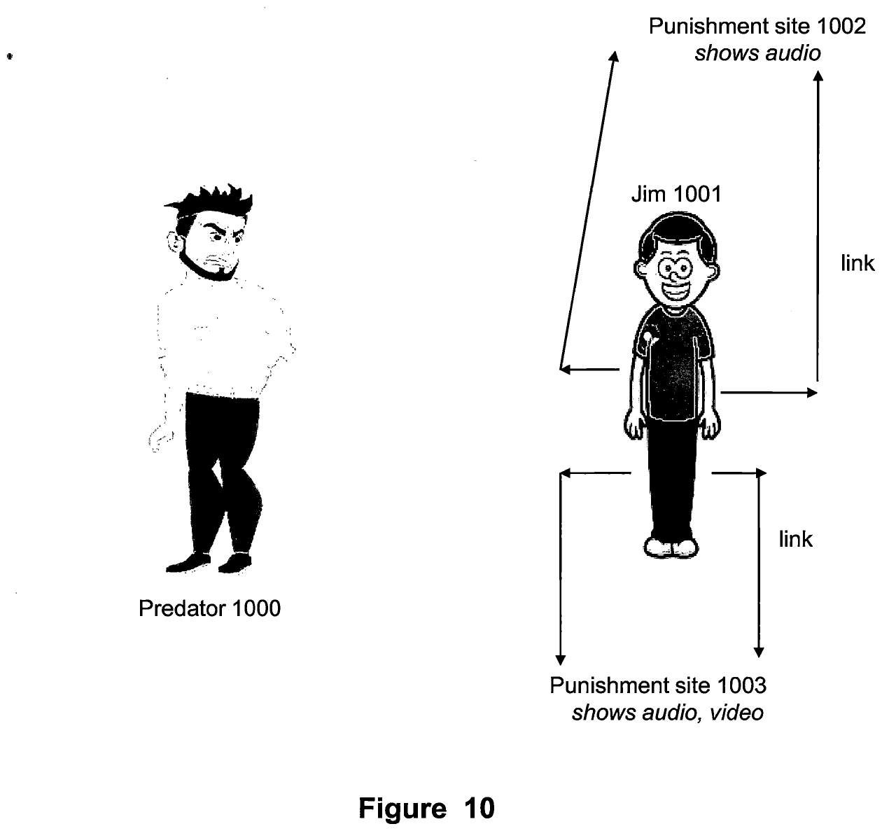

Suppose there is a Predator avatar 1000 who wants to do a non-sexual assault on avatar Jim 1001. See FIG. 10. Here, any use of a hyperlink from the victim's underwear to a punishment site is moot. Instead we consider a case where the Predator might be doing assaults against several victims. And these assaults are not gender-linked. Victim Jim might be outfitted with a co-host Guardian, as described in application “Metaverse antirape measures”, Ser. No. 17/803,375. Here, the Guardian is a human skilled in self defense. She inhabits Jim, and sees his optical feed. But she does not control his limbs. If a suspected Predator approaches, the owner of Jim hands control of the limbs to the Guardian. The owner is now passively just watching thru Jim's eyes. The Guardian then defends Jim using Jim's body. Another method described in that application is where a Guardian is not used. Instead, the owner can increase Jim's speed and strength and use this to directly defend against the Predator.

The hyperlink method for an avatar's underwear, described in earlier sections of this application and in “Metaverse anti rape measures—part 2”, Ser. No. 17/803,559, can also be altered to handle the case of this section.

A hyperlink can be attached to the entire outside surface of Jim. Or that surface can be divided into several sections. Like his head, his back, his groin. Etc. And a hyperlink is made for each section, pointing to a punishment site.

There can be several punishment sites, chosen as a function of the severity of the assault by the Predator. Punishment site 1002 can be for hyperlinks from Jim's arms. This site cam involve a mild punishment. While punishment site 1003 can be for hyperlinks from Jim's knees. This site is for a heavier punishment because the Predator hits his knees.

For example, punishment site 1002 can just play discordant audio to the Predator. While punishment site 1003 can do that and also show video that makes viewers (more) nauseous.

For simplicity and pedagogic clarity, FIG. 10 only shows 2 choices of “off limits” areas on Jim.

Because an avatar wearing a Jump hyperlink cannot be discerned from when the avatar wears no links, this in itself can keep a Predator guessing about the vulnerability of potential victims. This might dissuade assaults on avatars.

The use of Jump hyperlinks in place of simplistic bundling up of avatars in clothing or padding to ward off Predators also lets the avatars maintain a freedom of clothing choices.

A camouflage variant is where avatar Jim deliberately wears clothing that suggests he is wearing Jump hyperlinks. But these hyperlinks are a mirage. The idea is that an ostentatious flaunting of such links can suffice to ward off a Predator. He is acting as a “free rider”. He benefits from the presence of avatars with non-visible Jump hyperlinks as they walk thru VR sites.

In earlier sections we described how the Predator and victim can be swapped in a punishment site. So the (real) Predator finds himself being beaten by (apparently) a (fake) Predator. And where the (real) Predator might see glimpses in his visual feed of himself as a (fake) victim. This can also be done here. The site holding the male victim Jim 1001 can send a copy of Jim to the punishment site. And the site will send the Predator to that punishment site if he hits Jim in an off limits area. Thus the end scenario here is the same as earlier. Except, of course, that the Predator might see not himself but a (fake) victim Jim when the Predator appears in the punishment site.

We claim:

1: A system of punishing a sexual harasser in a multiuser computer environment with avatars, comprising:
having a site Alpha and a punishment site (PS);
Alpha having a Predator avatar and a victim avatar;
the victim having an off-limit area of its body that is not meant to be touched by other avatars;
the area being connected by a hyperlink to the PS;
the Predator touching the off-limit area;
Alpha sending the Predator to the PS;
the PS copying the Predator into a Fake Predator (FP);
the FP attacking the Predator;
the Predator seeing itself being attacked by a copy of itself.

2: The system of claim 1, where:
the PS immobilizes the limbs of the Predator.

3: The system of claim 1, where:
the FP is operated by a human.

4: The system of claim 1, where:
the FP is operated by a software engine (“bot”).

5: The system of claim 1, where:
a copy of the victim is sent to the PS;
the PS immobilizes the limbs of the copy of the victim;
the FP attacking the copy of the victim;
a visual feed seen by the copy of the victim is sent to the Predator;
the Predator seeing itself as the victim being attacked by a copy of the Predator.

6: A system of punishing a sexual harasser in a multiuser computer environment using avatars, comprising:
having a site Alpha and a punishment site (PS);
Alpha having a Predator avatar and a victim avatar;
the victim having an off-limit area of its body that is not meant to be touched by other avatars;
the area being connected by a hyperlink to the PS;
the Predator touching the off-limit area;
Alpha sending the Predator to the PS;
Alpha sending a first copy of the victim to the PS;
the PS animating the first copy of the victim;
the first copy of the victim attacking the Predator;
the Predator seeing itself being attacked by the first copy of the victim.

7: The system of claim 6, where:
the PS immobilizes the limbs of the Predator.

8: The system of claim 6, where:
the animating of the first copy of the victim is done by a combat engine (bot).

9: The system of claim 6, where:
the animating of the first copy of the victim is done by a human.

10: The system of claim 9, where:
the animating of the first copy of the victim is done by the human who owns the victim.

11: The system of claim 6, where:
the Predator has haptic effects enabled;
the Predator is hit by the copy of the victim;
the Predator feels an impact of the hit.

12: The system of claim 6, where:
the first copy of the victim has haptic effects enabled;
the first copy of the victim hits the Predator;
the first copy of the victim feels an impact of the hit.

13: The system of claim 6, where:
the PS makes one or more copies of the victim from the first copy of the victim;
the PS animating all the copies of the victim;
the copies of the victim attacking the Predator;
the Predator seeing itself being attacked by all the copies of the victim.
